(19) United States
(12) Patent Application Publication
(10) Pub. No.: US 2004/0037921 A1
(43) Pub. Date: Feb. 26, 2004

(54) Raw material for agricultural use and its applictions

(75) Inventors: Kazuo Hokkirigawa, Miyagi-Ken (JP); Motoharu Akiyama, Nagano-Ken (JP); Noriyuki Yoshimura, Nagano-Ken (JP)

Correspondence Address: SCHULTE ROTH & ZABEL LLP, ATTN: JOEL E. LUTZKER, 919 THIRD AVENUE, NEW YORK, NY, 10022, US

(73) Assignee: Minebea Co., Ltd., Nagano-ken (JP)

(21) Appl. No.: 10/452,240

(22) Filed: May 30, 2003

(30) Foreign Application Priority Data
Jun. 4, 2002 (JP) 2002-163640

(51) Int. Cl. A23L 1/31

(52) U.S. Cl. 426/59

(57) ABSTRACT

A biodegradable putty-like material which can be molded under pressure into containers to hold seedlings or young plants. The putty like material contains defatted rice bran and water which are kneaded and heated together to create the putty like material for agricultural use.

### CROSS-REFERENCE TO RELATED APPLICATIONS

This application claims all rights of priority to Japanese Patent Application Serial No. 2002-163640, filed Jun. 4, 2002.

### FIELD OF THE INVENTION

The present invention relates to a raw material for agricultural use which uses defatted rice bran to create a seedling-growing flowerpot or agricultural sheet.

### BACKGROUND OF THE INVENTION

Rice bran, which is removed from rice to produce polished rice, has typically been discarded as useless after its oils have been removed. The inventors have conducted research to find an effective use for this material, referred to as defatted rice bran. Although research has been conducted to make use of natural materials and biodegradable plastics, there has been no active research into the use of defatted rice bran as an agricultural raw material.

Research conducted by the inventors into effective uses of rice bran as a material for agricultural use which can easily degrade in the environment in a natural cycle has resulted in this invention. The invention is a putty-like material obtained by kneading the defatted rice bran with water over a long period of time. The carbohydrates in the defatted rice bran turn the defatted rice bran into a putty-like material, and this putty-like material can then be formed, under pressure, into a variety of containers.

### SUMMARY OF THE INVENTION

Approximately 33 million tons of defatted rice bran is produced worldwide each year, 900,000 tons of which is produced in Japan. Defatted rice bran from any kind of rice can be used in this invention after the oils from the rice bran have been removed. With kneeling and the addition of water and heat, the defatted rice bran is formed into a putty like material which can then be shaped into different containers to hold seedlings and young plants. The containers with the seedlings and plants can then be planted into the ground. Over time, the container breaks down and disintegrates naturally without causing harm to the environment.

In another embodiment of the invention, different starches are added to the putty like material to add more formability to the provided material.

Additionally, the putty like material may have an improved formability when biodegradable plastics are added to the putty like material.

In another embodiment, capsule fertilizers and capsule agricultural chemicals can be added to the putty like material to assist in plant growth.

In a further embodiment, materials that promote plant growth, such as dried clay, dried plants, minerals, and dried animal manure can be added to the putty like material.

The above aspects, advantages and features are of representative embodiments only. It should not be understood that they are not to be considered limitations on the invention as defined by the claims. Additional features and advantages of the invention will become apparent in the following description, from the drawing and from the claims.

### DETAILED DESCRIPTION OF THE PREFERRED EMBODIMENT

In accordance with the invention, in order to create the putty like agricultural material, water is added to the defatted rice bran. The amount of water blended into the defatted rice bran can be varied as needed, so that the moisture content of the putty-like material is varied within the range of 20%-80% according to the target application. The mixture is then kneaded while being heated to a temperature between 40° C. and 100° C. to obtain a putty-like material. Although the temperature needed to convert the defatted rice bran is between 40° C. and 100° C., the preferred temperature is between 50° C. and 70° C. This putty like material can then be molded into various shapes and containers by applying pressure to the material. The formed molds are then used to hold seedlings or plants. At appropriate time, the molds with the seedlings or plants are planted into the ground. As the plant grows the mold breaks down and disintegrates naturally thus having a low impact on the environment.

Further, one or more starches, such as natural starches, cereals, tubers, proteins, viscous polysaccharides, cellulose inducers, and mannan can be added to the putty-like material in order to increase its formability. Natural starches suitable for an addition to the putty like material are white potato starch, sweet potato starch, wheat flour starch, rice starch, corn starch, tapioca starch, soluble starches and dextrin, to name a few. Cereals can include wheat flour, rice flour, chestnut flour, millet flour, buckwheat flour, corn flour, barley flour, rye flour and sorghum flour cereals, among others. Tubers can be white potato flour, sweet potato flour, Jerusalem artichoke flour, taro flour, yam flour, etc. Additionally, proteins, for example gelatin and gluten, can be added to the putty-like material . The mixing ratio of natural starch should be 70-95:30-5 (mass ratio). Preferably, the ratio should be 80-90:20-10 (mass ratio).

Moreover, another means to increase the formability of the putty-like material is to add one or more types of biodegradable plastics. More specifically, biodegradable polyester resin compositions are formulated with the necessary components. These resins compositions are of fatty acid polyesters (A), polylactone (B), and polyester copolymers (C) having at least one of the monomer constituent units comprising of copolymers, fatty carbonic acid where at least 60 mole % of the 2-hydroxy 2-alkyl acetic acid units is lactic acid residue, and polymers including fatty acid polyester synthesized from fatty acid polyol. The mixing ratio of biodegradable plastics should be a 60-95:40-5 (mass ratio). Preferably, the ratio should be 75-90:25-10 (mass ratio).

To promote plant growth, capsule fertilizers and capsule agricultural chemicals are added to the putty-like material. Any kind of capsule fertilizer or capsule agricultural chemical is acceptable for use with this invention. The preferred capsule fertilizers and agricultural chemicals are those which are covered in water-soluble resins or degradable resins, and become effective at a set time. There is no particular limitation on the amount of additive, and the amount can be determined according to the purpose.

Further promotion of plant growth may be achieved by using one or more of the following: dried clay, minerals, dried plants, or dried animal manure. These materials are added as water-retaining materials to the putty-like material. Other absorbents which may be used in this invention include dried black soil, akadama soil, mulch, compost, and kanuma soil. Useful absorbents, other than soils, may be dried vermiculite, pyrite, zeolite, bentonite, and other minerals. Dried plant material, such as dried peat moss, coconut shells, tree bark, dried grass, rice hulls, sawdust, and others, may be used. Also, dried livestock waste, such as dried poultry droppings, dried horse manure, and dried cow manure, may be used. Particularly good results are obtained when dried compost, dried horse manure, dried peat moss, dried sawdust, dried rice hulls, dried grass, and dried straw are used in combination.

During the empirical studies, defatted rice bran obtained from rice bran was combined with water in the proportions shown in Table 1. The defatted rice bran and water were then heated to between 50° C.-60° C. and kneaded for approximately 24 hours to obtain a mendable uniformly-mixed putty-like mixture. The final water content was about 45 mass %. Natural starches, biodegradable plastics, capsule fertilizers, and absorbents were also added to this putty-like material and kneaded to obtain a uniform and formable substance. Polyester which contains polylactone was used as the biodegradable plastic. The capsule fertilizer used had 3:1:1 mass ratio of nitrogen, phosphorous, and potash. Next, the mendable, putty-like material of types 1 through 8 was formed under pressure of 22 MPa into flowerpots having an outer diameter of 15 cm, an inner diameter of 14.5 cm, and a height of 20 cm.

TABLE 1

| | | Type 1 | Type 2 | Type 3 | Type 4 | Type 5 | Type 6 | Type 7 | Type 8 |
|---|---|---|---|---|---|---|---|---|---|
| Defatted rice bran (kg) | | 10 | 10 | 10 | 10 | 10 | 10 | 10 | 10 |
| Water content of putty | | 45 | 45 | 45 | 40 | 55 | 60 | 50 | 50 |
| (%) | | | | | | | | | |
| Natural | Starch | | 1 | 0.5 | | | 1 | | |
| starches | CMC | | | | 1 | | 1 | | 1 |
| (kg) | Corn | | | | | 1 | | 1 | |
| | Wheat flour | | | | | 1 | | | 1 |
| | Gelatin | | | 0.5 | | | 1 | | |
| Biodegradable plastic | | | | 0.5 | 3 | 1 | 5 | 3 | 5 |
| (kg) | | | | | | | | | |
| Capsule fertilizer (kg) | | | 0.1 | 0.1 | | 0.1 | | | |
| Absorbent | Peat moss | | 0.5 | | | 0.5 | | | |
| (kg) | Rice hulls | | | 1 | | | 1 | | 1 |
| | Dried horse | | | | 1 | 1 | | 1 | |
| | manure | | | | | | | | |

Table 2 shows the results of using each type of the formed flower pots. The flowerpots were buried in 30 cm of black soil from spring to autumn, and were dug up after six months. Visual observations of the quantity of microorganisms adhering to the surface of the flowerpots were made and described as follows:

| | |
|---|---|
| ⊙ | Very large quantity of microorganisms |
| ◯ | Large quantity of microorganisms |
| Δ | Small quantity of microorganisms |

These observations served as criteria for bacterial biodegradability. Also, the mendable, putty-like material of types 1 through 8 was extruded into a 1 mm thick film. It was found that some embodiments could be formed into film and some could not. Corn seedlings were planted in the flowerpots when they were formed, and visual observations of the seedlings' growth were made and described as follows:

| | |
|---|---|
| ⊙ | Extremely fast growth |
| ◯ | Fast growth |
| Δ | No difference |

The growth rates of seeds planted into the flower pots formed in accordance with the invention were compared with the growth rates of seeds planted in commercially-available bisque flower pots of the same size.

TABLE 2

| | Embod. | Embod. | Embod. | Embod. | Embod. | Embod. | Embod. | Embod. |
|---|---|---|---|---|---|---|---|---|
| | 1 | 2 | 3 | 4 | 5 | 6 | 7 | 8 |
| Compressive strength (MPa) | 5 | 10 | 10 | 30 | 15 | 50 | 30 | 40 |
| Ability to form a film | no | No | no | yes | no | yes | yes | yes |
| Bacterial degradability | Δ | ◯ | ◯ | ⊙ | ⊙ | ◯ | ⊙ | ◯ |
| Seedling growth | Δ | ◯ | ◯ | ⊙ | ⊙ | Δ | ⊙ | ◯ |

To see if the same results occurred when the putty like material was formed into a sheet, types 4, 6, 7, and 8 were formed under pressure of 20 MPa into an agricultural sheet (60 cm×100 cm×0.5 cm). Using the same test method, results were similar.

The present invention succeeded in making highly-effective use of defatted rice bran, a material which is usually simply discarded. As shown in Table 2, the material is fully degradable in nature when planted. The invention produced a material for agricultural use which goes through a natural cycle and has a low impact on the environment.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

We claim as follows:

1. A raw material for agricultural use comprising:
a quantity of defatted rice bran; and
a quantity of water,
wherein said quantity of defatted rice bran is mixed with said quantity of water, kneaded and heated to form a putty like material.

2. A raw material for agricultural use as stated in claim 1 wherein the quantity of defatted rice bran is heated to a temperature between 40° C. and 100° C.

3. A raw material for agricultural use as stated in claim 2 wherein the quantity of defatted rice bran is heated to a temperature between 50° C. and 70° C.

4. A raw material for agricultural use as stated in claim 1 wherein the putty like material has a moisture content between 20% and 80%.

5. A raw material for agricultural use as stated in claim 1 wherein a natural starch is added to the putty like material.

6. A raw material for agricultural use as stated in claim 1 wherein a variety of natural starches is added to the putty like material.

7. A raw material for agricultural use as stated in claim 5 wherein the mixing ratio of the natural starch is 70-95.

8. A raw material for agricultural use as stated in claim 6 wherein the mixing ratio of the natural starches is 70-95.

9. A raw material for agricultural use as stated in claim 7 wherein the mixing ratio of the natural starch is 80-90.

10. A raw material for agricultural use as stated in claim 8 wherein the mixing ratio of the natural starches is 80-90.

11. A raw material for agricultural use as stated in claim 1 wherein a biodegradable plastic is added to the putty-like material.

12. A raw material for agricultural use as stated in claim 11 wherein the mixing ratio of the biodegradable plastic is 60-95.

13. A raw material for agricultural use as stated in claim 12 wherein the mixing ratio of the biodegradable plastic is 75-90.

14. A raw material for~agricultural use as stated in claim 1 wherein a capsule fertilizer is added to the putty like material.

15. A raw material for agricultural use as stated in claim 1 wherein a capsule agricultural chemical is added to the putty like material.

16. A raw material for agricultural use as stated in claim 1 wherein an absorbent is added to the putty like material.

17. A method for forming a raw material for agricultural use, comprising the steps of:
mixing a quantity of defatted rice bran with a quantity of water; and
kneading and heating said mixture of said quantity of defatted rice bran and said quantity of water to form a putty like material.

18. A method for forming a raw material for agricultural use, as stated in claim 17, further comprising a step of molding said putty like material into an agricultural container.

19. A method for forming a raw material for agricultural use, as stated in claim 17, further comprising a step of adding a natural starch to said putty like material.

20. A method for forming a raw material for agricultural use, as stated in claim 17, further comprising a step of adding a biodegradable plastic to said putty like material.

21. A method for forming a raw material for agricultural use, as stated in claim 17, further comprising a step of adding a capsule fertilizer to said putty like material.

22. A method for forming a raw material for agricultural use, as stated in claim 17, further comprising a step of adding a capsule agricultural chemical to said putty like material.

23. A method for forming a raw material for agricultural use, as stated in claim 17, further comprising a step of adding an absorbent to said putty like material.
